(19) United States
(12) Patent Application Publication
(10) Pub. No.: US 2004/0167956 A1
(43) Pub. Date: Aug. 26, 2004

(54) Method and apparatus for executing division

(76) Inventor: Jaako Vihriala, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/484,163

(22) PCT Filed: Aug. 6, 2002
(86) PCT No.: PCT/FI02/00654

(30) Foreign Application Priority Data
Aug. 7, 2001 (FI) 20011610

(51) Int. Cl. G06F 7/52

(52) U.S. Cl. 708/654

(57) ABSTRACT

A method of executing division and an electronic apparatus implementing the method are provided. In the method, an auxiliary divisor is retrieved from a look-up table stored in the electronic apparatus, the auxiliary divisor being a predetermined number generated by the product of the powers of the integer two and the reciprocal of the divisor. In the method, the division is executed in the electronic apparatus by multiplying the dividend of the division by the auxiliary divisor. The result of the division is scaled in the electronic apparatus in order to represent it in the desired form by shifting the result obtained by multiplying.

### FIELD

The invention relates to a method of executing division and to an electronic apparatus for implementing the method.

### BACKGROUND

Division is one of the basic arithmetic operations performed in various applications, including telecommunications technology. Typical measures including divisions include matrix inversion and normalization.

Usually divisions are executed using different iterative methods. An example is the Newton-Raphson algorithm, which solves the equation f(x)=0 by several iterations by means of the tangent, i.e. derivative f′(x) of the graph of function f(x). The iteration is initiated by selecting a starting value x₀ and placing it in the equation

$${x}_{i + 1} = {x}_{i} - \frac{f ( {x}_{i} )}{f \cdot ( {x}_{i} )} .$$

Typically, the number of iterations is three or four. In practice, division may be executed also by subtracting the divisor from the dividend so many times that the result is less than the divisor. Thus, the integer part of the quotient is obtained as the number of subtractions. A disadvantage of the method is the very high number of iterations required in some cases. Another disadvantage is that the decimal part of the quotient is not obtained directly.

The time consumed by iterations depends on the function concerned. When functions requiring relatively much time, such as divisions, are executed, slowness may become a problem. It is a problem particularly in telecommunication applications, in digital signal processing, for example.

Prior art iterative methods are usable in both fixed point and floating point processors. When floating point representation is used, a number is expressed by means of the mantissa and the exponent, the number of bits reserved for them being fixed, whereas in fixed point representation the number of bits indicating the decimal parts is a constant dependent of the representation. The Newton-Raphson algorithm is applied particularly when executing divisions with floating point numbers, whereas the iterative method, in which the divisor is subtracted from the dividend, is usable in fixed point applications.

Prior art iterative algorithms are often used in fixed point processors in many applications, including telecommunications technology, because of economic reasons, for example. The disadvantage herein is that the accuracy of the result of the calculation usually cannot be improved after two or at most three iterations. Thus, the problem is to achieve the required accuracy, i.e. resolution. Methods that execute the division accurately do exist, but their problem is slowness. An apparatus executing the division in one clock cycle can also be implemented for a processor. However, in practice, such an embodiment would take up a considerable portion of the silicon area of the processor or the ASIC implementation, i.e. would not be economically reasonable.

Implementing prior art iterative solutions as floating point number processors, results in good accuracy. However, the execution of calculations in a floating point number processor requires more logic than in a fixed point processor. A floating point number processor is therefore slower than a fixed point processor. The operations to be carried out with floating point numbers are also more complex than those with fixed point numbers. Compared with fixed point processors, floating point number processors have also the disadvantage that to execute a given operation requires more memory space in a floating point number processor than in a fixed point processor. This is disadvantageous particularly economically, since the portion of memory space required in digital signal processing, for example, is generally also otherwise large. Thus, for example ASIC implementations or most digital signal processing processors (DSP) do not support floating point number implementations.

Prior art iterative algorithm solutions typically use a look-up table (LUT), in which the desired numerical values are stored or from which the initial value is retrieved. In a look-up table, numerical values have addresses corresponding to their locations, using which the numerical values can be picked into calculations executed by algorithms. The look-up tables used require much memory space in a processor, which is an economic disadvantage.

A practical problem caused by the above prior art solutions is that for instance in digital signal processing, the performance of a receiver is unreasonably compromised if an algorithm implementation does not achieve high-quality resolution, i.e. accuracy. Furthermore, when prior art iterative solutions are used in digital signal processing, for example, a plurality of chained conditional structures are required, their problem being slowness.

### BRIEF DESCRIPTION

The object of the invention is to provide an improved method of executing division and an improved electronic apparatus for executing division. An aspect of the invention is the method according to claim 1. An aspect of the invention is the apparatus according to claim 13. Other preferred embodiments of the invention are described in the dependent claims.

The invention is based on solving a division by multiplying the dividend by a tabulated value of an auxiliary divisor, the values of the auxiliary divisor being predetermined numbers generated by the product of the powers of the integer two and the reciprocal of the divisor and stored in a look-up table, the result of the division being then scaled in order to represent it in the desired form by shifting the result obtained by multiplying.

In accordance with the method, the division is executed by using simple and fast calculation operations, such as multiplications, additions and subtractions. According to the invention, the division is executed by utilizing pre-tabulated numbers, generated by means of the product of the reciprocal of the divisor and powers of two. Multiplication and division by the powers of two is easy and can be performed in practice by shifting. In the method, the reciprocals of the divisor are computed in advance and tabulated in a look-up table, whereby the desired division is transformed into faster executable multiplications, additions, subtractions, and shifting, which present the result in the desired form.

An advantage of the method is that it allows the division to be executed in one calculation cycle without time-consuming iterations, making calculation fast. Transforming division into simple and fast calculations also makes the method fast. The method only uses one look-up table, from which the auxiliary divisor corresponding to the desired divisor is retrieved. Thus, a further advantage is that several look-up tables are not required for storing partial division results, whereby less memory space is required. Another advantage of the method is its good calculation accuracy. The fastness and accuracy of the method are of use particularly in telecommunication applications, in which speed and accurate calculations are essentially significant. The apparatus of the invention is economically advantageous particularly in telecommunication applications because the solution requires less memory space and is simple to implement.

The solution of the invention is typically usable in radio systems, e.g. the GSM (Global System for Mobile Communications) and WCDMA systems (Wideband Code Division Multiple Access) or other cellular radio systems. The method is applicable in radio systems in several areas, digital signal processing or communication, for example. The method is typically applicable to adaptive antennas or fast adaptive filters, such as RLS or Kalman filters, for example. Typical operations requiring divisions include matrix inversion and normalization, for example.

### LIST OF FIGURES

The preferred embodiments of the invention are described by way of example with reference to the attached drawings, in which:

FIG. 1 is a flow diagram of a preferred embodiment for executing division;

FIG. 2 is a flow diagram of an alternative embodiment of a second preferred embodiment;

FIG. 3 shows an example of an electronic apparatus for executing division;

FIG. 4 shows an example of an ASIC implementation of an apparatus for executing division;

FIG. 5 shows an example of a graph of a look-up table.

### DESCRIPTION OF THE EMBODIMENTS

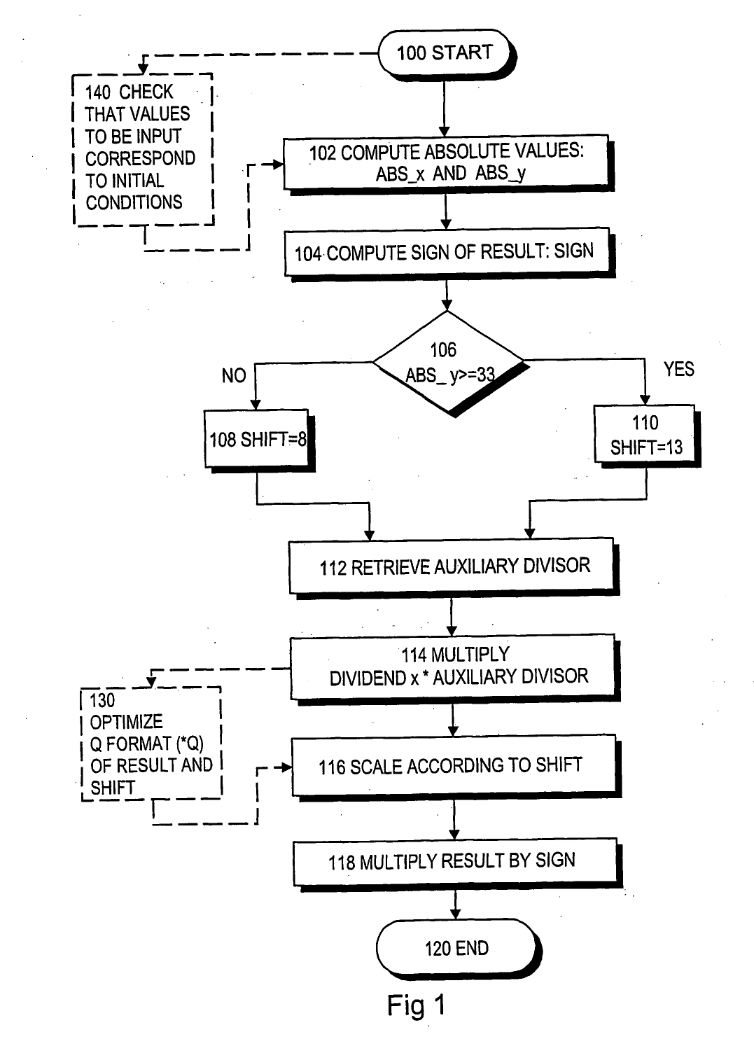

The method of executing division is described with reference to FIG. 1. The program printout of the solution of the preferred embodiment according to FIG. 1 is shown in Appendices 1 and 3.

In the preferred embodiment of FIG. 1, the assumption is that dividend x and divisor y are 8-bit signed integers, see Appendix 1, printout 1, and Appendix 3, printout 6, and the desired result is a 16-bit signed integer in the Q8 format, see Appendix 1, printout 1, and Appendix 3, printout 6. However, in the method, the number of bits is not limited, but the size of the table and the amount of memory used are kept small when the number of bits used is as in the preferred embodiment of FIG. 1.

The Q format is a 16-bit format, wherein a given number of bits designate the integer part of a number and a given number of bits the decimal part of the number. In the Q format, the parameter after Q indicates the number of bits reserved for the decimal part of the number. Correspondingly, the number of bits reserved for the integer part of the number is obtained by subtracting the format parameter from the number 16. For example, the Q13 format means that 13 bits are reserved for the decimal part of a number and 16-13=3 bits for the integer part of the number. The Q8 format is a 16-bit binary format used in digital signal processing (DSP), for example. The first eight bits denote the integer part of a number in an 8-bit binary form. The latter eight bits designate the decimal part of the number in an 8-bit form, wherein each bit signifies the number two raised to a negative power of its index (starting from the number −1). Numbers may be expressed using complements of two, whereby the logic required by addition and subtraction, for example, is simplified. In practice, nearly all processors or ASIC implementations use complements of two to express integers.

The preferred embodiment of FIG. 1 uses a look-up table, see the example in Appendix 3, printout 3, in which look-up table predetermined numbers, auxiliary divisors, are stored in advance. The stored numbers, or auxiliary divisors, are numbers generated by means of the product of powers 2^{Q(y)} of the integer two and the reciprocal

$$\frac{1}{y}$$

of divisor y, wherein Q(y) is an integer dependent on the value of y.

The auxiliary divisors stored in the look-up table depend on the clause,

$$\frac{{2}^{Q ( y )}}{y} ,$$

i.e. they are of the form

$$f ( \frac{{2}^{Q ( y )}}{y} ) ,$$

wherein f denotes a function whose argument is

$$\frac{{2}^{Q ( y )}}{y} ,$$

is the desired divisor and Q(y) is an integer dependent on the value of y. The auxiliary divisors of the look-up table may also be in the form

$${f}^{- 1} ( \frac{{2}^{Q ( y )}}{y} ) ,$$

wherein f⁻¹ is the inverse function of function f, y is the desired divisor and Q(y) is an integer dependent on the value of y. Furthermore, the auxiliary divisors in the look-up table may be expressed in the form

$$\frac{{2}^{Q ( y )}}{y} or \frac{{2}^{Q ( y )}}{y} - 1 ,$$

wherein y is the desired divisor and Q(y) is an integer dependent on the value of y.

Consequently, the auxiliary divisors dependent on argument

$$\frac{{2}^{Q ( y )}}{y}$$

can be stored in the table in a form enabling the adjustment of the size of the numbers of the table and the size of the table, for example, to keep them within given limits or to facilitate subsequent calculations. An auxiliary divisor retrieved from the table can be further returned to the basic form

$$\frac{{2}^{Q ( y )}}{y}$$

before the dividend of the division is multiplied by an auxiliary dividend and the result of the division is scaled to express it in the desired form. For example, if the auxiliary divisor is expressed in the form

$$\frac{{2}^{Q ( y )}}{y} - 1 ,$$

the number 1 is added to it before it is multiplied by the dividend of the division.

In order for the size of the numbers in the table and the memory required by it not to increase too much, the size of the numbers in the table is restricted to 16 bits in the present exemplary case. In an SW implementation, a 17-bit number would require 32 bits of memory, see Appendix 3, printout 6. In the present example, the size of the numbers is restricted to 16 bits by storing, in the table, integers of the form

$$\frac{{2}^{Q ( y )}}{y} - 1 ,$$

where y is the divisor of the desired division operation and Q(y) is an integer dependent on the value of y. The advantage of the arrangement is that it enables the amount of memory required to be reduced.

In the preferred embodiment of FIG. 1, Q(y) is selected such that Q(y) is the integer 16 (table_Q1=16, see Appendix 3, printout 3) when the absolute value of divisor y is less than 33. When the absolute value of divisor y is greater than or equal to 33, the integer value 21 (table_Q2=21, see Appendix 3, printout 3) is selected for Q(y). However, in the method, the number of possible values of Q(y) is not limited to two, but their number can be arbitrary, provided that the values of Q are unsigned 8-bit integers (u8, unsigned char, see Appendix 3, printout 6). The values of Q(y) in the exemplary case are preferably selected such that the product

$$\frac{{2}^{Q ( y )}}{y}$$

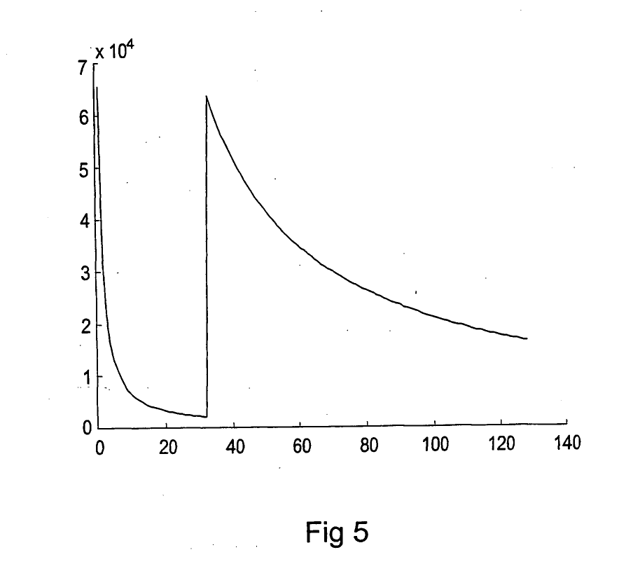

between the reciprocal of the divisor and the power 2^{Q(y)} of two remains between the desired minimum and maximum values, in this case 2¹⁶=65536, in binary form 10000000000000000, and does not reach them, and such that the size of the table is minimized. The advantage of the selected values of Q(y) is that when using them, the size of the table and the numbers remains small and they also achieve a sufficiently accurate result and a small maximum error as compared with an accurate value. FIG. 5 shows an example of the graph of a look-up table, the vertical axis showing the values of the auxiliary divisor presented in the table, and the horizontal axis the absolute values of divisor y. The discontinuity in the figure denotes the point where Q(y) is transformed from the value 16 into the value 21.

Let us execute by way of example the division between two numbers in accordance with the preferred embodiment of FIG. 1. Give dividend x the value 1 and divisor y the value 2. The number 1 is 1 in binary form and the number 2 is 10 in binary form.

In block 102, the absolute values of the divisor and the dividend are computed. In the example, the absolute value of the dividend abs_x=1 and the absolute value of the divisor abs_y=2.

In block 104, the sign of the result is computed. Since in the example, the dividend x>0 and the divider y>0, the sign of the result result_sign=1.

In blocks 106, 108, 110, a shifting value corresponding to the absolute value of the divisor is determined. In block 106, a check is made to see if the absolute value of divisor y is abs_y>=33. Since in the exemplary case abs_y=2<33, then, in accordance with block 108, the shifting value shift=Q(y)−8=table_Q1−8=16−8=8.

In block 112, the auxiliary divisor corresponding to divisor y is retrieved from the look-up table. In the exemplary case, the auxiliary divisor is inv_table[abs_y−1]=32767, see Appendix 1 and Appendix 3, printout 3.

In block 114, the division is executed by multiplying dividend x by the value of the tabulated auxiliary divisor, see Appendix 1. In the preferred embodiment of the example, the auxiliary divisors are stored in the form

$$\frac{{2}^{Q ( y )}}{y} - 1 ,$$

1, and thus the integer 1 is added to the auxiliary divisor retrieved from the look-up table. This gives the reciprocal of the divisor, inv_y, by which dividend x is multiplied, see Appendix 1. In the present example, inv_y=I+inv_table[abs_y-1]=1+32767=32768, which in binary number representation is 1000000000000000. Next, the binary numbers are multiplied, 1* 1000000000000000, yielding the binary number 1000000000000000.

In block 116, the result is scaled into the desired representation format. An arithmetic shifting is performed by adding 2^{shift-1} to the product and by further dividing it by the number 2^{shift}, i.e. shifting the thus obtained result 8 bits to the right. This is accomplished by shifting the number one 7 bits to the left and adding it to the product obtained 1000000000000000. In other words, 2^{shift-1}2⁸⁻¹=128 is added to the result obtained, in binary form 10000000, giving 1000000010000000. The result obtained is further shifted eight bits to the right, i.e. the result obtained is divided by the number 2^{shift=}2⁸=256, in binary number form 100000000. This yields the result 10000000 of the division, in unsigned form. Expressed as a 16-bit signed integer in the Q8 format, the result is 0000000010000000, wherein the first 8 bits are integer parts and the last 8 bits decimal parts. In accordance with the Q8 format, the number 1 in the result denotes the number 2⁻¹⁼½=0.5.

In block 118, the sign of the result is changed by multiplying it by the number −1, if necessary. In the exemplary case, it was found out in block 104 that the sign of the result 0000000010000000 is +1, and thus the sign of the result obtained does not have to be changed.

In the above-described preferred embodiment, block 104 may also be executed at any stage before the execution of block 118.

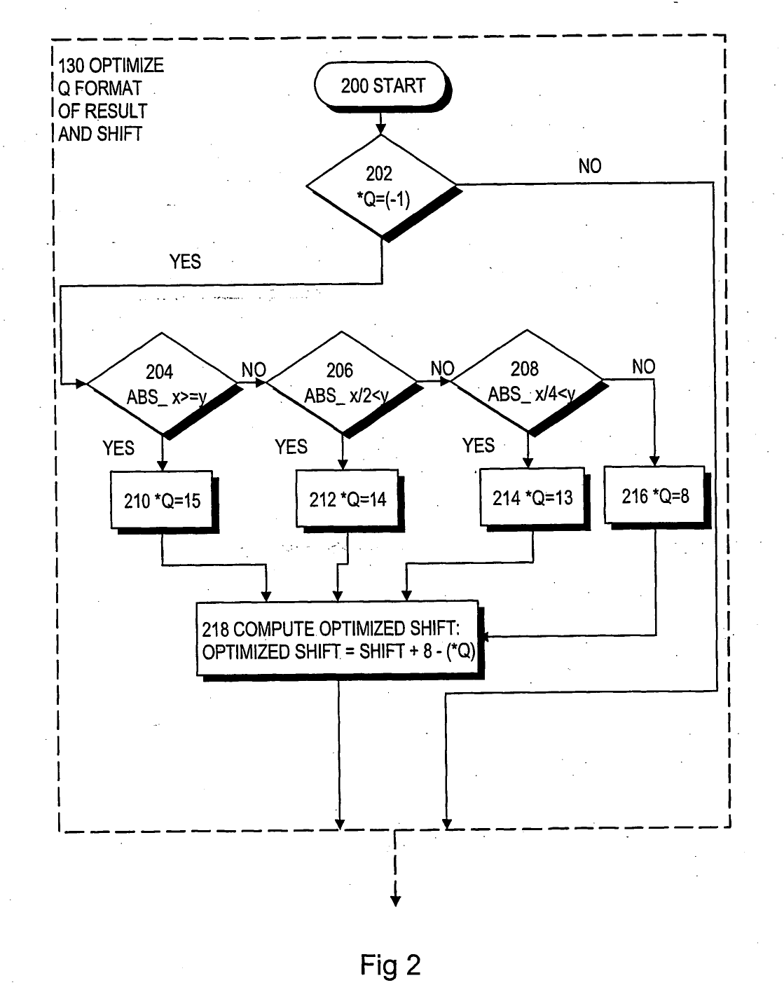

A second preferred embodiment will be described with reference to FIGS. 1 and 2. The program printout of the second preferred embodiment is in Appendices 2 and 3.

In the second preferred embodiment, the Q format, in which the result of the division is expressed, is optimized. In this embodiment, a check can also be made, before executing the division, to see that dividend x and divisor y fulfil the initial conditions set. Compared with the above-described preferred embodiment according to FIG. 1, the embodiment of FIGS. 1 and 2 yields a more accurate result. However, the embodiment of FIGS. 1 and 2 is slower and uses more memory space than the embodiment of FIG. 1.

In another preferred embodiment, the method of FIG. 1 is executed with the addition of block 130. In addition, block 140 may also be executed. When desired, block 140 may also be executed in the first preferred embodiment.

As an example, a division between two numbers is executed in accordance with the second preferred embodiment according to FIGS. 1 and 2. The result is to be expressed in an optimal Q format. The dividend (x) is given the value 1 and the divisor (y) is given the value −128. In binary form, the number 1 is 1 and the number −128 is 10000000.

In an optional block 140, a check can be made to see that the values to be input correspond to the initial-conditions. In accordance with the initial conditions of the preferred embodiment of the example, the numbers x and y to be input must not be smaller than −128 or greater than 128, and the number −128 to be input is saturated into the number −127. The number y must not be zero. In the present example, the number x fulfils the given initial conditions, but the number y=−128 does not, and therefore it is saturated into the number −127 in block 140, after which the process enters block 102.

In the exemplary calculation, blocks 102 to 114 are executed in the same way as in the first preferred embodiment. As shifting value is obtained 13, and as the product of the dividend and the auxiliary divisor 16384, in binary form 100000000000000.

In order for the program to optimize the desired Q format, *Q was given the initial value −1 at function call. Therefore, since in the exemplary case abs_x=1 and abs_y=127, the process continues from block 202 via block 204 to block 206 and further to block 212, where *Q receives the value 14. Accordingly, the result will be presented in the Q14 format, wherein 14 bits are reserved for the decimal part.

In block 218, the optimized shifting value is computed, which in the exemplary case is 13+8−14=7.

In the embodiment, the value of *Q can also be checked, i.e. see if the Q format is within allowed limits, i.e. between [0-16], see Appendix 2.

Blocks 116 and 118 are executed in the same way as in the first preferred embodiment, giving as the result the binary number 10000000. Presented in the Q14 format, the number is in the form 000010000000, where the first two (16-14=2) bits denote integer parts and the last 14 bits decimal parts. In accordance with the Q14 format, the number 1 in the result denotes the number

$${2}^{- 7} = \frac{1}{128} = 0.0078125 .$$

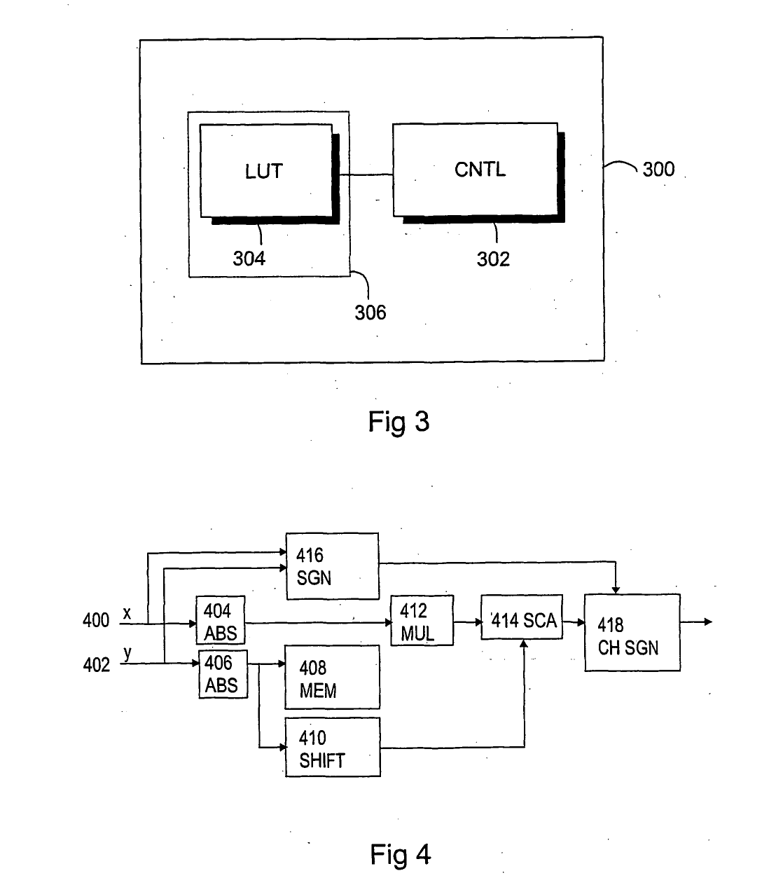

The electronic apparatus for executing division for implementing the method is described with reference to FIGS. 3 and 4.

The above-described method of executing division and the first preferred embodiment of the method according to FIG. 1, and the second preferred embodiment according to FIGS. 1 and 2 can be implemented with an electronic apparatus using the solution of FIG. 3. In FIG. 3, an electronic apparatus 300 comprises a look-up table 304, in which predetermined integers generated by means of the product of the powers of the integer two and the reciprocal of the divisor are stored. The electronic apparatus 300 further comprises means 302 for executing the calculation operations according to blocks 100 to 120 and 200 to 218 and 140 of the preferred embodiments of FIGS. 1 and 2.

The means 302 included in the electronic apparatus 300 for implementing the method are typically implemented as software to be executed in a processor. The look-up table 304 included in the apparatus is typically located in a memory 306 in the processor.

The means 302 included in the electronic apparatus 300 for implementing the method may also be either partially or totally implemented with electronics. A typically used technology in an electronics implementation is the ASIC technology (Application Specific Integrated Circuit). An example of an application implemented using the ASIC technology is shown in FIG. 4. In the ASIC implementation according to FIG. 4, the value of dividend x is input in block 400 and the value of divisor y is input in block 402. In blocks 404 and 406, the absolute values of the divisor and the dividend are computed. In block 408, a numerical value is retrieved for y from a memory whose size is 128*16 bits. In block 410, a shifting value shift is computed based on the value of y. In block 412, x and y are multiplied, and then in block 414, scaling is performed in accordance with the shifting value obtained in block 410. If need be, the sign of the result obtained is changed in block 418 in accordance with the sign defined in block 416, which completes the desired division.

Although the invention is described above with reference to the example according to the accompanying drawings, it is apparent that the invention is not limited thereto, but can be modified in a variety of ways within the scope of the inventive idea disclosed in the attached claims.

[image]

[image]

[image]

[image]

[image]

1. A method of executing division in an electronic apparatus, characterized by
(112) retrieving an auxiliary divisor from a look-up table stored in the electronic apparatus, the values of the auxiliary divisor in the look-up table being predetermined numbers generated by the product of the powers of the integer two and the reciprocal of the divisor and stored in the look-up table;
(114) division is executed in the electronic apparatus by multiplying the dividend of the division by the auxiliary divisor retrieved from the look-up table;
(116) scaling the result of the division in the electronic apparatus in order to represent it in the desired form by shifting the result obtained by multiplying.

2. A method as claimed in claim 1, characterized by the auxiliary divisors stored in the look-up table being in the form
$$f ( \frac{{2}^{Q ( y )}}{y} ) ,$$
where f is function, y is the divisor of the desired division operation, and Q(y) is an integer dependent on the value of y.

3. A method as claimed in claim 1, characterized by the auxiliary divisors stored in the look-up table being in the form
$${f}^{- 1} ( \frac{{2}^{Q ( y )}}{y} ) ,$$
where f⁻¹ is the inverse function of function f, y is the divisor of the desired division operation, and Q(y) is an integer dependent on the value of y.

4. A method as claimed in claim 1, characterized by the auxiliary divisors stored in the look-up table being in the form
$$\frac{{2}^{Q ( y )}}{y} - 1 ,$$
where y is the divisor of the desired division operation, and Q(y) is an integer dependent on the value of y.

5. A method as claimed in claim 1, characterized by the auxiliary divisors stored in the look-up table being in the form
$$\frac{{2}^{Q ( y )}}{y} ,$$
where y is the divisor of the desired division operation, and Q(y) is an integer dependent on the value of y.

6. A method as claimed in any one of claims 2 to 4, characterized by converting the auxiliary divisor retrieved from the look-up table into the basic form
$$\frac{{2}^{Q ( y )}}{y} ,$$
after which the division is executed by multiplying the dividend of the division by the auxiliary divisor.

7. A method as claimed in claim 4, characterized by adding the number 1 to the auxiliary divisor retrieved from the look-up table, after which the division is executed by multiplying the dividend of the division by the obtained sum.

8. A method as claimed in any one of the preceding claims, characterized by Q(y) being the integer 16 when the absolute value of divisor y is less than 32.

9. A method as claimed in any one of the preceding claims, characterized by Q(y) being the integer 21 when the absolute value of divisor y is greater than or equal to 33.

10. A method as claimed in any one of the preceding claims, characterized by the scaled result of the division being presented in the Q8 format.

11. A method as claimed in any one of the preceding claims, characterized by optimizing the Q format, in which the scaled result of the division is presented.

12. A method as claimed in any one of the preceding claims, characterized by checking, before the execution of the division, that the divisor and the dividend fulfil the initial conditions of the method.

13. An electronic apparatus for executing division, characterized in that the apparatus comprises:
a look-up table (304), in which auxiliary divisors are stored, the values of the auxiliary divisors being predetermined numbers generated by the product of the powers of the integer two and the reciprocal of the divisor and stored in the look-up table;
means (302) for retrieving an auxiliary divisor from the look-up table (304);
means (302) for executing the division by multiplying the dividend of the division by the auxiliary divisor retrieved from the look-up table;
means (302) for scaling the result of the division by shifting the number obtained as the result of the division obtained by multiplying in order to represent it in the desired form.

14. An electronic apparatus as claimed in claim 13, characterized in that the auxiliary divisors stored in the look-up table (304) are in the form
$$f ( \frac{{2}^{Q ( y )}}{y} ) ,$$
where f is function, y is the divisor of the desired division operation, and Q(y) is an integer dependent on the value of y.

15. An electronic apparatus as claimed in claim 13, characterized in that the auxiliary divisors stored in the look-up table are in the form
$${f}^{- 1} ( \frac{{2}^{Q ( y )}}{y} ) ,$$
where f⁻¹ is the inverse function of function f, y is the divisor of the desired division operation, and Q(y) is an integer dependent on the value of y.

16. An electronic apparatus as claimed in claim 13, characterized in that the auxiliary divisors stored in the look-up table (304) are in the form
$$\frac{{2}^{Q ( y )}}{y} - 1 ,$$
where y is the divisor of the desired division operation, and Q(y) is an integer dependent on the value of y.

17. An electronic apparatus as claimed in claim 13, characterized in that the auxiliary divisors stored in the look-up table are in the form
$$\frac{{2}^{Q ( y )}}{y} ,$$
where y is the divisor of the desired division operation, and Q(y) is an integer dependent on the value of y.

18. An electronic apparatus as claimed in any one of claims 14 to 16, characterized in that the auxiliary divisor retrieved from the look-up table is converted into the basic form
$$\frac{{2}^{Q ( y )}}{y} ,$$
after which the division is executed by multiplied the dividend of the division by the auxiliary divisor.

19. An electronic apparatus as claimed in claim 16, characterized in that the number 1 is added to the auxiliary divisor retrieved from the look-up table (304), after which the division is executed by multiplying the dividend of the division by the obtained sum.

20. An apparatus as claimed in any one of claims 13 to 19, characterized in that Q(y) is the integer 16 when the absolute value of divisor y is less than 32.

21. An electronic apparatus as claimed in any one of claims 13 to 20, characterized in that Q(y) is the integer 21 when the absolute value of divisor y is greater than or equal to 33.

22. An electronic apparatus as claimed in any one of claims 13 to 21, characterized in that the scaled result of the division is presented in the Q8 format.

23. An electronic apparatus as claimed in any one of claims 13 to 22, characterized in that the Q format, in which the scaled result of the division is presented, is optimized.

24. An apparatus as claimed in any one of claims 13 to 23, characterized in that before the execution of the division, a check is made to see that the divisor and the dividend fulfil the initial conditions of the method.
